(19) United States
(12) Patent Application Publication
(10) Pub. No.: US 2019/0023978 A1
(43) Pub. Date: Jan. 24, 2019

(54) PROPPANTS AND PROCESS FOR MAKING THE SAME

(71) Applicant: Saint-Gobain Ceramics & Plastics, Inc., Worcester, MA (US)

(72) Inventor: Jingyu SHI, Hudson, OH (US)

(21) Appl. No.: 16/034,408

(22) Filed: Jul. 13, 2018

Related U.S. Application Data
(60) Provisional application No. 62/535,628, filed on Jul. 21, 2017.

(51) Int. Cl. C09K 8/80

(52) U.S. Cl. CPC C09K 8/80; E21B 43/267

(57) ABSTRACT

A plurality of proppant particles that includes ultra fine and fine fractured proppants particles with certain physical and chemical characteristics is disclosed. The fractured proppant particles of this invention can be tailored to provide fracture slurries that have the characteristics needed to address the technical issues that arise during the fracturing and extraction phases of an oil well's life span.

### CROSS-REFERENCE TO RELATED APPLICATION

This application claims the benefit of U.S. Provisional Application No. 62/535,268 filed Jul. 21, 2017.

### FIELD OF THE INVENTION

This invention generally relates to ceramic particles that are useful in applications where high strength, low specific gravity and small physical size are desirable. More particularly, this invention is concerned with ceramic proppants that may be used to increase the efficiency of wells used to extract oil and gas from geological formations.

### BACKGROUND

The chemical and physical characteristics of proppants have been disclosed in numerous patents and patent applications including: U.S. Pat. No. 4,632,876; U.S. Pat. No. 7,067,445; US 2006/0177661; US 2008/0223574, US 2011/0265995, US 2016/0376495 and WO 2011/081549. Proppants may generally be classified as naturally occurring materials, such as sand, or man-made ceramic particles which are sintered to achieve good strength. Commercial processes used to manufacture proppants include the dry mixing process described in U.S. Pat. No. 4,427,068, columns 5 and 6, and the spray fluidization process disclosed in U.S. Pat. No. 4,440,866. Both of these processes are designed to produce ceramic particles that are spherical.

### SUMMARY

Embodiments of the present invention provide fractured proppant particles that may be used in geological formations that may include fissures which are too small to be propped open by many commercially available spherical proppants that have average diameters between 150 microns to 1000 microns.

In one embodiment, the present invention includes a plurality of fractured proppant particles that have a particle size distribution wherein at least 60 weight percent of the plurality of particles is capable of passing through a 325 mesh screen; has a chemical composition between 50 weight percent and 85 weight percent Al₂O₃, between 2 and 40 weight percent SiO₂, as measured by XRF; and a specific gravity between 2.30 and 3.70 g/cc.

Another embodiment relates to a plurality of fractured proppant particles that includes at least three populations of particles that have the following characteristics. A first population representing at least 60 weight percent of the plurality of particles and capable of passing through a 325 mesh screen. A second population representing between 10 and 30 weight percent of the plurality of particles and capable of passing through a 70 mesh screen but not a 325 mesh screen. A third population representing between 1 and 10 weight percent of the plurality of particles and unable to pass through a 70 mesh screen.

### BRIEF DESCRIPTION OF THE DRAWINGS

FIG. 1 is a flow chart of the steps used to characterize the particle size distribution of a plurality of fractured proppant particles;

FIG. 2 is a photograph of a plurality of commercially available proppants;

FIG. 3 is a photograph of a plurality of fractured proppant particles that did not flow through a 70 mesh screen;

FIG. 4 is a photograph of a plurality of fractured proppant particles that flowed through a 70 mesh screen and did not flow through a 325 mesh screen; and

FIG. 5 is a photograph of a plurality of fractured proppant particles that flowed through a 325 mesh screen.

### DETAILED DESCRIPTION

The description provided herein is intended to provide a skilled artisan with the ability to understand and practice the claimed invention. The specific embodiments describe how the invention can be practiced but should not be interpreted as limiting the scope of the claimed invention. In the specification, including the abstract and detailed description, the numerical values cited therein should be read as modified by the term “about” unless the specification already contains this modifier or specifically teaches to the contrary. In addition, ranges of values are intended to include each and every value in the range including the end points. For example, “between 2.30 and 3.70” should be read as disclosing each and every possible number between about 2.30 and about 3.70 and the ends points.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein, the word “alumina” refers to the chemical formula Al₂O₃, which is determined by x-ray fluorescence (XRF) and not the alumina crystalline phase which is determined by x-ray diffraction (XRD).

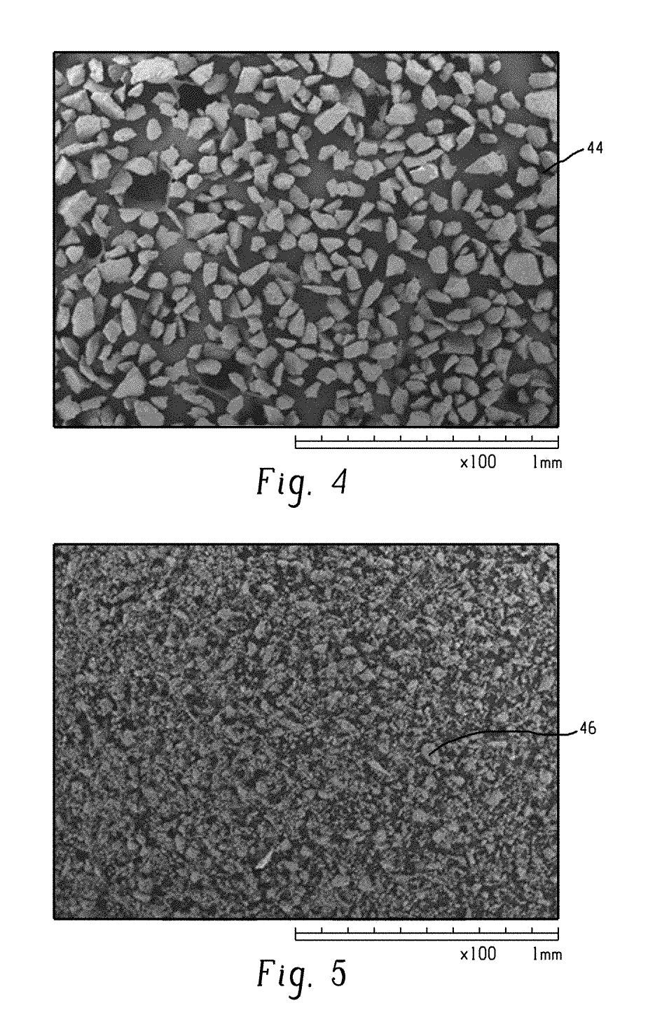

As used herein, the phrase “fractured proppant particles” means the plurality of fragments that are generated when a spherical ceramic particle is crushed. Majority of the fragments may be described as generally granular in shape with irregular, curvilinear surfaces that include random projections and recesses as disclosed in FIGS. 4 and 5. The granular fragments may appear to have an overall shape similar to a multi-sided solid component, such as a cube, cuboid, square pyramid, tetrahedron, octahedron, cone, or rod, with the surfaces altered by rounding, protrusions and/or recesses. Some of the fragments, such as less than 10 weight percent, may have a flake like shape. A fragment is considered to be flake like if the fragment's thickness is no more than about one-third of its length or width. For use herein, a fragment's thickness is less than its width which is less than length. If the fragment is generally disc shaped, which occurs when the fragment has a diameter rather than distinct length and width, then its thickness is no more than about one-third of its diameter.

To fully appreciate the impact that improvements to proppants can have on the proppant industry, its customers, and the environment, an overview of the processes used to manufacture and utilize the proppants will be provided below. Proppants are generally used in downhole wells, commonly known as oil wells or gas wells, to facilitate removal of hydrocarbon based fluids. The life span of an oil well can be described as comprising the following stages. First, the predrilling stage is the condition of the geological formation, both above ground and below ground, before onsite preparations to drill have started. Second, the drilling and fracturing stage begins when the drilling starts and continues through the vertical and horizontal (if any) drilling and any associated fracturing. The fracturing portion of this stage includes inserting proppants into the fissures and removing fracturing fluid from the wellbore after the well has been fractured and before commercially valuable hydrocarbon based fluids are extracted. Third, the extraction stage is the time or times when the fluids, such as hydrocarbon based fluids, are removed from the well. This is the stage during which valuable fluids are collected from the well. Fourth, the post extraction stage begins when fluids can no longer be removed from the well at a commercially viable rate and the well is allowed to become dormant. A dormant well may be permanently capped and the ground around the wellbore may be returned to a condition that approximates the environment that existed during the predrilling stage. The area below the surface of the earth retains the proppants that were injected during the fracturing operation.

The use of ceramic proppants can play an important role in the fracturing, extraction, and post extraction stages of an oil well's life span. During the fracturing stage, proppants are mixed with fracturing fluid to form a fracture slurry which is then forcefully pumped downhole so that the fissures in the earth are expanded by the fluid and proppants are driven into the fissures. The volumes, weights and specific gravities of the proppant and the fracturing fluid that are mixed together to form the fracturing slurry should be managed to insure that proppants are delivered into the fissures and do not flow back into the wellbore when the fracturing fluid is extracted or hydrocarbon fluids are removed. The composition of the fluid and the specific gravity, size and strength of the proppants may be controlled to maximize well production. The ability of the proppant to be carried downhole by the fracturing fluid is important. The diameter of the proppant plays a direct role in determining the size of the fissure that the proppant can enter. If the proppants are too large they cannot enter the fissure and may block off the flow of fluids from the fissure which would be undesirable. If the proppants are too small they may pack a large fissure with a proppant pack that has a low conductivity. Fourth, the proppants' range of diameters should be considered when attempting to maximize the total amount of fluids pumped from an oil well over its functional life time. Many patents directed to proppants have advocated the use of highly spherical proppants that have a distribution of diameters that is essentially monomodal. While a population of proppants with a high degree of sphericity and an essentially monomodal size distribution may perform well in a laboratory test that measures conductivity in an idealized situation, downhole conditions are believed to include a plurality of fissures that have a wide range of size openings. Consequently, a proppant population that has a distribution of particle sizes may be able to fully support the propping operation by providing both small proppants that can enter and prop open small fissures and large proppants that are better suited for propping large fissures.

In addition to understanding the life span of an oil well, understanding the life span of a proppant will facilitate an appreciation for the improvements described herein. Improvements in the field of manufacturing ceramic proppants have usually focused on a specific characteristic of the proppant such as improving its crush strength, reducing its specific gravity or improving its sphericity. However, issues that arise during any portion of the proppants' complete life cycle need to be considered. As used herein, the life cycle of a ceramic proppant particle may be described as beginning when the raw materials used to make the proppant are selected and the proppant manufacturing process has begun. The life cycle does not end when the wellbore into which the proppants have been inserted is capped or otherwise closed because the proppants remain underground and could impact the local environment. First, by allowing underground fluids from outside the well's drainage zone, which is the underground area from which fluids were extracted during the extraction stage, to migrate into the fissures that contain the proppants. The movement of fluids into the fissures that contain the proppants may be referred to herein as post extraction migration. While post extraction migration has not been studied by this inventor, this phenomenon could allow fluids, such as additional hydrocarbon based fluids, to eventually migrate into areas that had previously been occupied by the hydrocarbon based fluids that were removed during the extraction stage. In addition, the post extraction proppants could allow fluids to be pumped from the surface of the geological formation down into the fractured geological formation to the region that previously retained the fluids that were removed.

In addition to considering the life span of an oil well and the life span of a proppant, the inventor of this application considered the specific attributes and characteristics of ceramic proppants and how they could be modified to best meet the demands placed upon the proppant by its manufacturing process and on the proppant when it is inserted downhole. Sintered ceramic particles that function as proppants can be characterized by various attributes that pertain to at least the physical characteristics and the chemical characteristics of the individual proppants and the physical characteristics of the proppant pack. For example, with regard to the size of the proppant, as is well known to a person of skill in the field of manufacturing ceramic proppants, a series of screens may be used to identify the weight percentages of the plurality of particles that pass through a first screen but will not pass through a second screen provided the first screen has larger openings than the openings in the second screen. The screening process, which may be referred to herein as a sieving process, used to characterize the properties of proppants described herein is disclosed in International Standard ISO 13503-2, First Edition, 2006 Nov. 1. In Table 1 of ISO 13503-2, sieve opening sizes are provided. The proppant size range 70/140 represents the proppants that pass through a 70 mesh screen and will not pass through a 140 mesh screen. The sieve opening size for the 70 mesh screen is 212 microns and the sieve opening size for the 140 mesh screen is 106 microns. Other screens such as 50 mesh screen and 100 mesh screen are available and may be used to identify selected portions of the plurality of particles.

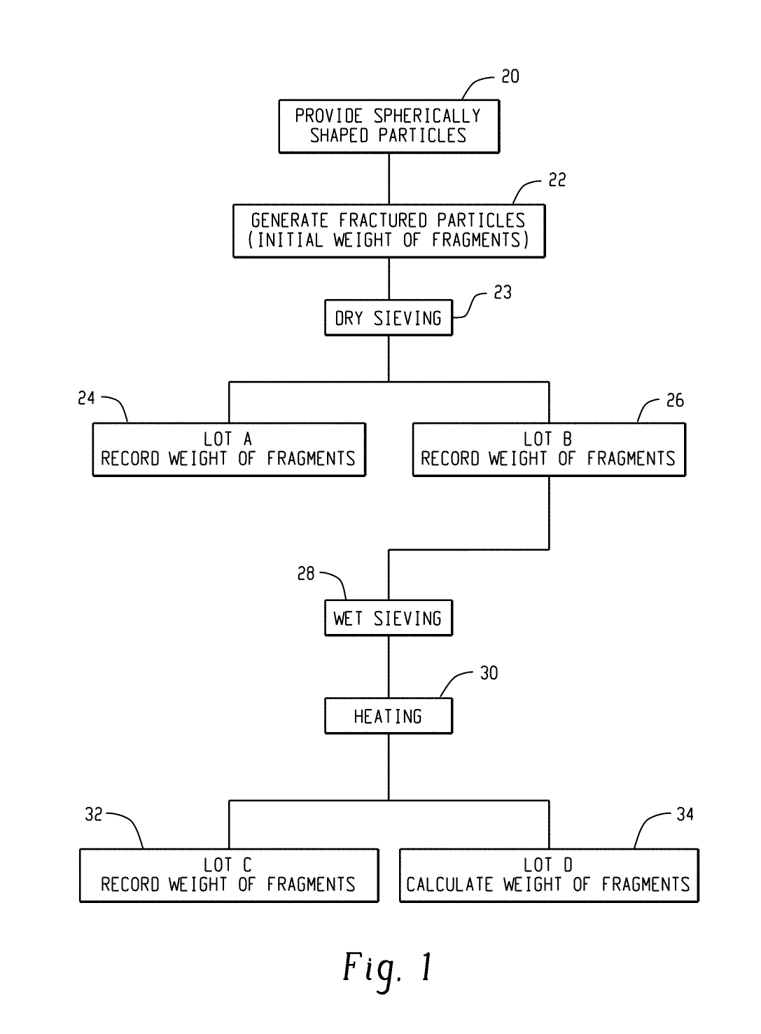

The particle size distribution of a plurality of fractured proppant particles of this invention can be determined using a dry sieving process and then a wet sieving process as will be described below. With reference to FIG. 1, in step 20 provide 100 g of generally spherically shaped particles that were not capable of flowing through a 40 mesh screen. In step 22, fracture the spherically shaped proppant particles by applying a compressive force to the particles thereby generating 100 g of fractured proppant particles which may be described as fragments and may be referred to herein as the initial weight of fragments. In step 23 use the dry sieving process that will now be described to screen the 100 g of fractured proppant particles. The dry sieving process involves securing a 70 mesh screen to a single speed RoTap® type RX-29 tapping machine, available from W. S. Tyler Company of Gastonia, N.C., USA, and then pouring the 100 g of fractured particles onto the screen. Run the tapping machine for ten minutes. The fragments that do not flow through the 70 mesh screen are designated herein as lot A. In step 24, record the weight of lot A. The weight of the fragments that flowed through the 70 mesh screen is designated herein as lot B. In step 26, record the weight of lot B. The fragments in lot B are then sieved through a 325 mesh screen using the following wet sieving process 28. The particles in lot B are evenly distributed across a 325 mesh screen. The screen and layer of fragments are then rinsed with a single stream of gently flowing water. The screen is slowly and continuously moved such that the stream repeatedly contacts and rinses all of the particles. The rinsing is intended to flush away particles that will flow through a 325 mesh screen. Rinsing is continued until the water exiting from the bottom of the screen is clear which indicates that essentially all of the fragments that will pass through the 325 mesh screen have been removed. The 325 mesh screen with the wet fragments retained thereon is then heated in an oven, step 30, at approximately 110° C. until the water has been removed. The plurality of dried fragments, which are designated herein as lot C, are then carefully and completely removed from the screen. The weight of the dried fragments is designated herein as weight C. In step 32, record the weight of lot C. The particles that flowed through the 325 mesh screen, which is designated herein as lot D, cannot be directly measured and, in step 34, must be calculated as will now be described.

The percentage of fragments that are unable to pass through a 70 mesh screen is determined by dividing the weight of lot A by the initial weight of fragments (i.e. 100 g). The percentage of fragments that were able to pass through a 70 mesh screen but not through a 325 mesh screen is determined by dividing the weight of lot C by the initial weight of fragments. The percentage of fragments that were able to pass through a 325 mesh screen, which is designated herein as lot D, is calculated by subtracting the weights of both lots A and C from the initial weight of fragments and then dividing by the initial weight of fragments. For example, in a hypothetical example, if a 100 g sample of fragments was analyzed as described above and the weight of lot A was 7 g and the weight of lot C was 20 grams then the weight of the fragments that passed through the 325 mesh screen must have been 73 grams or 73 weight percent of the initial weight of fragments.

Another physical characteristic that may be useful in identifying a plurality of particles is the “angle of repose” which is an indication of the flowability of the particles. The angle of repose has not been widely used to characterize proppants because most commercially available proppants were spherically shaped so that the angle of response was expected to be so low as to be meaningless. However, the angle of repose of the fractured proppants described herein may provide a unique way to identify a plurality of proppants that meet the apparently contradictory requirements that proppants must flow freely into fissures in the earth during the insertion portion of the fracturing operation but then remain in place and not “flow back” out of the fissures when the fracturing fluid is removed. The angle of repose can be impacted by factors such as the particles' surface roughness, the particles' shape and the distribution of particle sizes in the plurality of particles.

Another physical characteristic is the crush resistance of a plurality of proppants which may be determined using the procedure described in ISO 13503-2.

Yet another physical characteristic is the conductivity of a plurality of particles, which may be configured as a bed of proppants, and can be determined using ISO 13503-5. Conductivity is a measure of the resistance that the bed of proppants exerts on a fluid as it flows through the bed of proppants.

Crystalline phase is yet another physical attribute that can be used to characterize a proppant. X-Ray Diffraction (XRD) can be used to determine the proppant's crystalline phases as well as the quantity of amorphous phase. With regard to the crystalline phases, an X-ray diffractometer, such as an PANalytical® XRD, is used to detect the existence of one or more crystalline phases. The height of the lines on the X-ray diffraction pattern may be used to determine the relative quantities of each crystalline phase. The location of the lines on the X-ray diffraction pattern's horizontal axis is indicative of a crystalline phase. Furthermore, the use of an internal standard may enable the calculation of the amount of amorphous phase which does not show in X-ray diffraction pattern.

With regard to chemical characteristics, the chemical composition of the particles may be determined by preparing a fused sample of the proppant and then using an x-ray fluorescence (XRF) analytical apparatus to determine the weight percentages of each element in oxide form, such as aluminum oxides, silicon oxides and iron oxides. A fused sample of the proppant may be prepared using a Claisse M4 Fluxer Fusion apparatus (manufactured by Claisse of Quebec City, Canada) as follows. Several grams of the proppant are manually ground so that the finely ground proppant passes through a 75 μm (200 Tyler mesh) sieve. In a platinum crucible supplied by Claisse, 1.0000 g (+0.0005 g) of the ground and screened proppant is mixed with 8.0000 g (±0.0005 g) of lithium borates 50-50 which contains a releasing agent such as LiBr or CsI. If the releasing agent is not included in the lithium borate, three drops of a releasing agent (25 w/v % LiBr or CsI) may be added. The mixture in the crucible is then gradually heated in order to remove any organic materials, moisture, etc. Simultaneously, the crucible is rapidly spun so that centrifugal force caused by the spinning drives any entrapped gas from the molten material. When the temperature of the molten proppant in the crucible reaches approximately 1000° C., the material has been liquefied and the crucible is tilted so that the molten proppant flows into a disc mold. While the molten material is cooling in the disc mold, a fan blows air on the mold to facilitate the removal of heat. As the molten proppant cools the material fuses and forms a disc shaped sample that measures approximately 3 cm wide and 4 mm thick. The disc should not contain any gas bubbles trapped therein. The chemical composition of the cooled disc is then determined using a model MagiX Pro Philips X-Ray Fluorescence analyzer running IQ+ software.

After considering the life spans of a wellbore and proppant and the physical and chemical characteristics of a proppant, the inventor of the subject application investigated numerous combinations of chemical and physical characteristics and unexpectedly found that the proppants described below that contain fragments of crushed proppants provide a unique blend of large and small non-spherical proppants that are believed to be well suited to prop open fissures in geological formations that have a variety of opening sizes. One aspect of this invention addresses the problem of how to make non-spherical proppant particles that have the physical and chemical characteristics needed to function as proppant in downhole applications. Most commercially available proppant manufacturing processes are designed to make generally spherical proppants. Because these processes cannot be readily adapted to make non-spherical proppant particles, there is a need for a new process to make fractured proppant particles which may be referred to herein as fragments. The non-spherical proppants have physical characteristics that are distinguishable over commercially available spherical proppants. Consequently, fracture slurries with previously unattainable characteristics are now believed to be possible.

Fractured proppant particles that perform adequately in deep wells, which are defined herein as an oil or gas well with a drainage field more than three thousand meters below the earth's surface, benefit from having a chemical composition that is at least 50 weight percent Al₂O₃. An alumina content above 85 weight percent is possible but not preferred because it increases both the particles cost and its specific gravity which are not desirable. The alumina content of the particle could be reduced to 80, 75 or even 70 weight percent if the specific gravity of the particle needed to be reduced to be more closely aligned with the specific gravity and/or viscosity of the fracturing fluid. Particles with alumina content of 50 weight percent could provide adequate crush strength in wells with drainage fields less than three thousand meters deep.

In addition to the alumina, particles with 2 to 40 weight percent SiO₂ are preferred. If desired the SiO₂ content could be less than 30, 25 or even 20 weight percent. The combined weight of the Al₂O₃ and SiO₂ should represent at least 70 weight percent of the particle's original weight which is the weight of the particle before it has undergone additional processing such as resin coating etc. The combined weight of the Al₂O₃ and SiO₂ could be 75, 80 or even 85 weight percent of the particle's total weight. Other elements or compounds could be available in small quantities such as less than 15 weight percent.

The size of the individual fractured particles needs to be controlled to insure an adequate and appropriate mixture of particle sizes. Unlike many commercially available proppants that attempt to limit particle size distribution to a monomodal distribution, this invention recognizes the unexpected benefit of generating in situ and from a plurality of generally spherical proppants a plurality of fractured particles with a first population, a second population and a third population as will now be described. The first population of fractured particles will pass through a 325 mesh screen. The second population of fractured particles will pass through a 70 mesh screen but not through a 325 mesh screen. The third population of fractured particles will not pass through a 70 mesh screen. Additional populations that will not pass through screens with openings larger than 70 mesh are possible but not required. The particles that pass through a 325 mesh screen may be referred to herein as ultra fine fractured proppant particles and should account for more than 60 weight percent of the total weight of the particle population. The weight percent of the ultra fine fractured proppant particles could be 65, 70 or 75 weight percent of the total weight of the particles. If the weight percent of ultra fine fractured proppant particles exceeds 88 weight percent of the total weight of the particle's population, the viscosity of the fracturing slurry could become so low that it would be difficult to pump downhole. The total weight of the ultra fine fractured proppant particles could be 85 or even 80 weight percent of the total weight of the particles. If the weight percent of ultra fine fractured proppant particles is less than 60 weight percent of the total particle population, then the quantity of ultra fine fractured proppant particles available downhole to penetrate and prop open micron size fractures could be too small to improve the productivity of the well.

In addition to at least 60 weight percent ultra fine fractured proppant particles, a plurality of fractured proppant particles that pass through a 70 mesh screen but not a 325 mesh screen, which are defined herein as fine fractured proppant particles, are believed to be useful in propping fractures with widths in the range of a few millimeters. The fine fractured proppant particles may represent 10 to 30 weight percent of the total weight of proppants. The population of fine fractured proppant particles may also be referred to herein as the second population of fractured proppant particles. The second population may be no less than 12 or even 14 weight percent of the total weight of the fractured proppant particles. If desired, the second population may be no greater than 28 or even 26 weight percent of the total weight of the fractured proppant particles. Increasing the percentage of fine fractured proppant particles and simultaneously reducing the percentage of ultra fine fractured proppant particles by the same amount may allow the percent solids in the fracturing slurry to be increased without a corresponding increase in the viscosity of the fracturing slurry.

In addition to at least 60 weight percent ultra fine fractured proppant particles and at least 10 weight percent of the fine fractured proppant particles, a plurality of fractured proppant particles with 1 to 10 weight percent particles that will not pass through a 70 mesh screen are referred to herein as large proppant particles and are believed to be useful in propping fractures wider than a few millimeters. This population of fractured proppant particles may also be referred to herein as the third population of fractured proppant particles. The third population may be no less than 1 or even 3 weight percent of the total weight of the fractured proppant particles and no greater than 10 or even 9 weight percent of the total weight of the particles. Fractured proppant particle populations with the maximum amount (i.e. 10 weight percent) of particles in the third population and a corresponding reduction in the percentage of ultra fine fractured proppant particles would be useful in fracturing slurries that are viscous and could entrain a higher percentage of the larger fragments.

The specific gravity of the population of fractured proppant particles, which may be referred to herein as the composite specific gravity, can range between 2.30 g/cc and 3.70 g/cc. Intermediate values such as 2.40, 2.60, 2.80, 3.00, 3.20, 3.40 and 3.60 g/cc are feasible. The composite specific gravity may be adjusted by changing the percentages of the first, second and third populations of proppant particles. A fractured proppant particle population that has the maximum amount of ultra fine proppant fragments (i.e. 88 weight percent) and the minimum amount of fine and large proppant fragments will have a higher specific gravity than a particle population with a minimum amount of ultra fine proppant fragments (i.e. 60 weight percent) and maximum amount of fine fragments (i.e. 30 weight percent) and large (i.e. 10 weight percent) proppant fragments. By adjusting the percentages of fractured proppant particles within the specified ranges the specific gravity of the plurality of fractured proppant particles can be adjusted to accommodate different levels of solids loading and/or viscosity requirements in the fracturing slurry.

A method of manufacturing a population of fractured proppant particles described herein may involve a multistep fracturing process For example, spherical particles that will not flow through a 40 mesh screen where they are exposed to a compressive force which fractures the particles a first time into fragments wherein all of the fragments flow through a 40 mesh screen and at least some of the fragments will not flow through a 70 mesh screen. The fragments that would not flow through the 70 mesh screen are fractured again upon continued exposure to the compressive force until at least some of the particles will pass through a 70 mesh screen and will not flow through a 325 mesh screen. Upon yet additional exposure to the compressive force the particles that would not flow through the 325 mesh screen are fractured yet again until some of the fragments will pass through a 325 mesh screen. Spherical particles that respond to an initial compressive force by rapidly crumbling into ultra fine fractured proppants, which are fragments that flow through a 325 mesh screen, without first fracturing into large fragments, which are fragments that will not flow through a 70 mesh screen, and fine size fragments, which are fragments that will flow through a 70 mesh screen but not a 325 mesh screen, are not preferred. The advantage of fracturing first into large and fine size fragments and then fracturing into ultra fine size in response to one or more subsequent compressive forces is that the particle size distribution of the final population of fractured proppant particles can be altered to include fragments that include large, fine and ultrafine fragments. As described above, large fragments cannot pass through a 70 mesh screen. Fine fragments can flow through a 70 mesh screen but not a 325 mesh screen. Ultra fine fragments are able to pass through a 325 mesh screen.

A multistep fracturing process begins with a plurality of generally spherical ceramic particles that may have certain physical and chemical characteristics. Desirable physical characteristics may include selected values for total porosity, pore size distribution and location of pores that collectively influence how the spherical particle initially fractures in response to the exertion of a compressive force applied to the particle. Other physical properties that can be used to influence the particles' primary and secondary fracture patterns include the particle's crystalline phase(s) and the amount (if any) of amorphous phase material. Chemical characteristics include the amount of alumina and the presence of non-alumina compounds.

One method of manufacturing the population of fractured proppant particles described herein involves crushing generally spherical particles thereby generating fragments that have a sphericity less than 0.8 according to ISO 13503-2. At least 60 weight percent of the third population of fractured proppant particles described above may have a sphericity of 0.80 or less. The weight percent of the third population with a sphericity less than 0.8 could be 70 or even 80 weight percent. Furthermore, the weight percent of the third population with a sphericity of 0.7 or lower could be 70 or even 80 weight percent.

An example of a manufacturing process that can be used to make proppant fragments that have at least 60 weight percent of the population of particles capable of passing through a 325 mesh screen, at least 10 weight percent capable of passing through a 70 mesh screen but not a 325 mesh screen, and at least 1 weight percent not capable of passing through a 70 mesh screen will now be described. Provide an initial plurality of generally spherical ceramic particles wherein the particles will not pass through a 40 mesh screen and have an average sphericity greater than 0.8. Crush the initial plurality of particles using a means for grinding such as a ball mill wherein the ball mill has a tubular shaped enclosure and grinding media contained therein. The ball mill rotates along an axis that is concentric with the tubular shaped enclosure. The initial plurality of spherical particles are allowed to strike one another as well as the grinding media and walls of the enclosure. The grinding process causes the generally spherical proppants to be fractured along primary fracture lines thereby creating fractured proppant particles. Although the fracture mechanism of the initial plurality of proppants has not been studied, the presence of pores within the initial proppants may tend to stop the propagation of cracks which would probably minimize the creation of large fragments. The existence and location of the pores may be influenced by the processing conditions and materials used to manufacture the spherical proppants.

The percentages of ultrafine, fine and large size fragments generated from the initial charge of proppants fed into a ball mill can be influenced by the following operating conditions. First, the ratio of the volume of grinding media to the volume of initial proppants. Second, the speed at which the ball mill rotates. Third, the material from which the media is made and the size of the media relative to the size of the initial proppant particles. Fourth, the length of time(s) that the initial proppant particles are in the mill. For example, if the ball mill is operated in a batch mode and the initial charge of proppant particles is split into three portions the first portion could be inserted into the ball mill for a fixed period of time and the ball mill then stopped. The second portion could then be inserted into the ball mill with the first portion and the ball mill could then be run for another fixed period of time that may be the same as or different from the first fixed period of time. The ball mill would then be stopped and the third and final portion of the initial population of proppant particles could then be inserted with the first and second portions and the ball mill made to run for yet another fixed period of time. By selecting the quantities of initial proppants in the first, second and third portions and the lengths of time that ball mill was run before adding additional initial proppants the particle size distribution can be adjusted as desired to attain the percentages of ultra fine proppant fragments, fine proppant fragments and large proppant fragments.

Alternatively, the ball mill could be operated in a continuous mode instead of a batch mode. In a continuous mode the particle size distribution of fractured proppants could be controlled by adjusting the characteristics of the initial charge of proppants. For example, the initial charge of proppants could contain three sub-populations that were distinguished by differences in average porosity. The first sub-population may have very little porosity and would fracture into ultra fine fragments. The second sub-population may have higher porosity with many pores and would tend to fracture into the fine size fragments. The third sub-population may also have higher porosity but with just a few large pores and would tend to fracture into the large fragments.

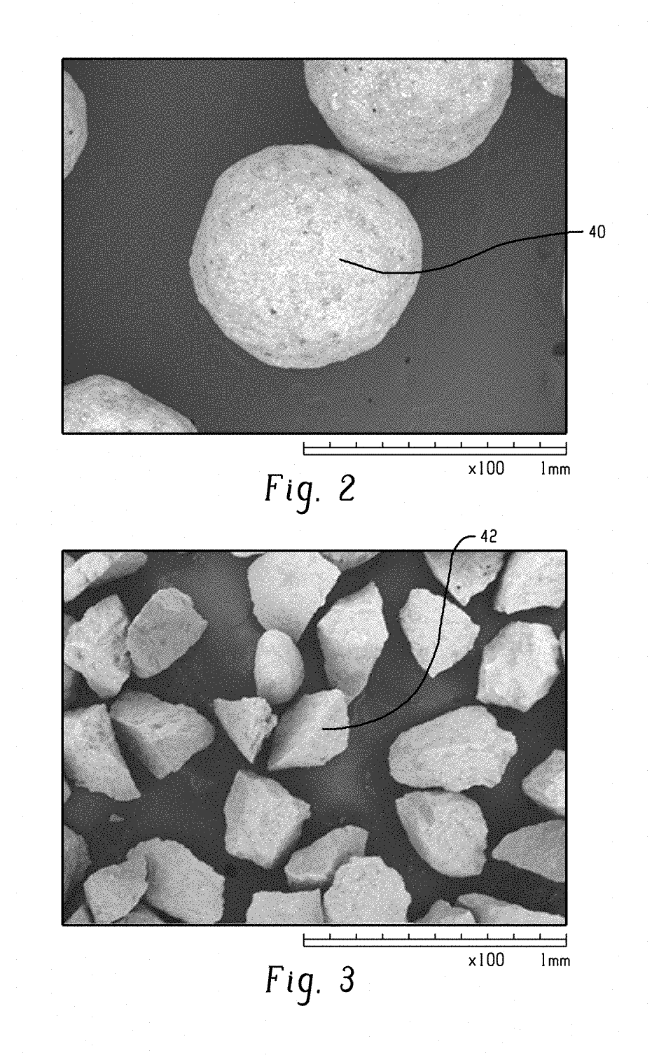

Referring now to the drawings and more particularly to FIG. 2, there is shown a photograph of a commercially available spherical proppant particle 40 made by a dry mixing process. The particle is approximately 0.5 mm in diameter. FIG. 3 discloses proppant fragments 42 that cannot pass through a 70 mesh screen as described in this invention. FIG. 4 discloses proppant fragments 44 that have passed through a 70 mesh screen but could not pass through a 325 mesh screen as described in this invention. FIG. 5 discloses proppant fragments 46 that flowed through a 325 mesh screen as described in this invention.

Many different aspects and embodiments of the invention disclosed herein are possible. After reading this specification, skilled artisans will appreciate that those aspects and embodiments are only illustrative and do not limit the scope of the present invention. Embodiments may be in accordance with any one or more of the embodiments as listed below.

### Embodiment 1

A plurality of fractured proppant particles, comprising:

(a) a particle size distribution wherein at least 60 weight percent of said plurality of particles is capable of passing through a 325 mesh screen;

(b) said particles' chemical composition comprising between 50 weight percent and 85 weight percent Al2O3 and between 2 and 40 weight percent SiO2, as measured by XRF; and

(c) said particles' specific gravity between 2.30 and 3.70 g/cc.

### Embodiment 2

The plurality of particles of embodiment 1 wherein at least 65 weight percent of said plurality of particles are capable of passing through a 325 mesh screen.

### Embodiment 3

The plurality of particles of embodiment 1 wherein at least 70 weight percent of said plurality of particles are capable of passing through 325 mesh screen.

### Embodiment 4

The plurality of particles of embodiment 1 wherein said chemical composition comprises less than 80% Al₂O₃.

### Embodiment 5

The plurality of particles of embodiment 1 wherein said chemical composition comprises less than 75% Al₂O₃.

### Embodiment 6

The plurality of particles of embodiment 1 wherein said chemical composition comprises less than 70% Al₂O₃.

### Embodiment 7

The plurality of particles of embodiment 1 wherein said chemical composition comprises less than 30% SiO₂.

### Embodiment 8

The plurality of particles of embodiment 1 wherein said chemical composition comprises less than 25% SiO₂.

### Embodiment 9

The plurality of particles of embodiment 1 wherein said chemical composition comprises less than 20% SiO₂.

### Embodiment 10

The plurality of particles of embodiment 1 wherein said specific gravity is greater than 2.40 g/cc.

### Embodiment 11

The plurality of particles of embodiment 1 wherein the sphericity of at least 60 percent of said particles are less than 0.8.

### Embodiment 12

The plurality of particles of embodiment 1 wherein the sphericity of at least 70 percent of said particles are less than 0.8.

### Embodiment 13

The plurality of particles of embodiment 1 wherein the sphericity of at least 80 percent of said particles are less than 0.8.

### Embodiment 14

The plurality of particles of embodiment 1 wherein the sphericity of at least 70 percent of said particles are less than 0.7.

### Embodiment 15

The plurality of particles of embodiment 1 wherein the sphericity of at least 80 percent of said particles are less than 0.7.

### Embodiment 16

A plurality of fractured proppant particles comprising at least three populations of particles having the following characteristics:

(a) a first population representing at least 60 weight percent of said plurality of particles and capable of passing through a 325 mesh screen;

(b) a second population representing between 10 and 30 weight percent of said plurality of particles and capable of passing through 70 mesh but not 325 mesh screens; and

(c) a third population representing between 1 and 10 weight percent of said plurality of particles and unable to pass through a 70 mesh screen.

### Embodiment 17

The plurality of particles of embodiment 16 wherein said third population of particles has an average sphericity less than 0.7.

### Embodiment 18

The plurality of particles of embodiment 16 wherein said first population represents at least 65 weight percent of said plurality of particles.

### Embodiment 19

The plurality of particles of embodiment 16 wherein said first population represents at least 70 weight percent of said plurality of particles.

### Embodiment 20

The plurality of particles of embodiment 16 wherein said first population represents at least 75 weight percent of said plurality of particles.

### Embodiment 21

The plurality of particles of embodiment 16 wherein said second population represents at least 12 weight percent of said plurality of particles.

### Embodiment 22

The plurality of particles of embodiment 16 wherein said second population represents at least 14 weight percent of said plurality of particles.

### Embodiment 23

The plurality of particles of embodiment 16 wherein said second population represents less than 28 weight percent of said plurality of particles.

### Embodiment 24

The plurality of particles of embodiment 16 wherein said second population represents less than 26 weight percent of said plurality of particles.

### Embodiment 25

The plurality of particles of embodiment 16 wherein said third population represents at least 3 weight percent of said plurality of particles.

### Embodiment 26

The plurality of particles of embodiment 16 wherein said third population represents less than 9 weight percent of said plurality of particles.

### Embodiment 27

The plurality of particles of embodiment 16 wherein said first population represents less than 88 weight percent of said plurality of particles.

### Embodiment 28

The plurality of particles of embodiment 16 wherein said first population represents less than 85 weight percent of said plurality of particles.

### Embodiment 29

The plurality of particles of embodiment 16 wherein said first population represents less than 80 weight percent of said plurality of particles.

The above description is considered that of particular embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law.

What is claimed is:

1. A plurality of fractured proppant particles, comprising:
(a) a particle size distribution wherein at least 60 weight percent of said plurality of particles is capable of passing through a 325 mesh screen;
(b) said particles' chemical composition comprising between 50 weight percent and 85 weight percent Al₂O₃ and between 2 and 40 weight percent SiO₂, as measured by XRF; and
(c) said particles' specific gravity between 2.30 and 3.70 g/cc.

2. The plurality of particles of claim 1 wherein at least 65 weight percent of said plurality of particles are capable of passing through a 325 mesh screen.

3. The plurality of particles of claim 1 wherein at least 70 weight percent of said plurality of particles are capable of passing through 325 mesh screen.

4. The plurality of particles of claim 1 wherein said chemical composition comprises less than 80% Al₂O₃.

5. The plurality of particles of claim 1 wherein said chemical composition comprises less than 75% Al₂O₃.

6. The plurality of particles of claim 1 wherein said chemical composition comprises less than 70% Al₂O₃.

7. The plurality of particles of claim 1 wherein said chemical composition comprises less than 30% SiO₂.

8. The plurality of particles of claim 1 wherein said chemical composition comprises less than 25% SiO₂.

9. The plurality of particles of claim 1 wherein said chemical composition comprises less than 20% SiO₂.

10. The plurality of particles of claim 1 wherein said specific gravity is greater than 2.40 g/cc.

11. The plurality of particles of claim 1 wherein the sphericity of at least 60 percent of said particles are less than 0.8.

12. The plurality of particles of claim 1 wherein the sphericity of at least 70 percent of said particles are less than 0.8.

13. The plurality of particles of claim 1 wherein the sphericity of at least 80 percent of said particles are less than 0.8.

14. The plurality of particles of claim 1 wherein the sphericity of at least 70 percent of said particles are less than 0.7.

15. The plurality of particles of claim 1 wherein the sphericity of at least 80 percent of said particles are less than 0.7.

16. A plurality of fractured proppant particles comprising at least three populations of particles having the following characteristics:
(a) a first population representing at least 60 weight percent of said plurality of particles and capable of passing through a 325 mesh screen;
(b) a second population representing between 10 and 30 weight percent of said plurality of particles and capable of passing through 70 mesh but not 325 mesh screens, and
(c) a third population representing between 1 and 10 weight percent of said plurality of particles and unable to pass through a 70 mesh screen.

17. The plurality of particles of claim 16 wherein said third population of particles has an average sphericity less than 0.7.

18. The plurality of particles of claim 16 wherein said first population represents at least 65 weight percent of said plurality of particles.

19. The plurality of particles of claim 16 wherein said first population represents at least 70 weight percent of said plurality of particles.

20. The plurality of particles of claim 16 wherein said first population represents at least 75 weight percent of said plurality of particles.

21. The plurality of particles of claim 16 wherein said second population represents at least 12 weight percent of said plurality of particles.

22. The plurality of particles of claim 16 wherein said second population represents at least 14 weight percent of said plurality of particles.

23. The plurality of particles of claim 16 wherein said second population represents less than 28 weight percent of said plurality of particles.

24. The plurality of particles of claim 16 wherein said second population represents less than 26 weight percent of said plurality of particles.

25. The plurality of particles of claim 16 wherein said third population represents at least 3 weight percent of said plurality of particles.

26. The plurality of particles of claim 16 wherein said third population represents less than 9 weight percent of said plurality of particles.

27. The plurality of particles of claim 16 wherein said first population represents less than 88 weight percent of said plurality of particles.

28. The plurality of particles of claim 16 wherein said first population represents less than 85 weight percent of said plurality of particles.

29. The plurality of particles of claim 16 wherein said first population represents less than 80 weight percent of said plurality of particles.
